(19) United States
(12) Patent Application Publication
(10) Pub. No.: US 2026/0057412 A1
(43) Pub. Date: Feb. 26, 2026

(54) METHOD, DEVICE, AND MEDIUM FOR CONTENT SEARCHING

(71) Applicant: Beijing Zitiao Network Technology Co., Ltd., Haidian District (CN)

(72) Inventors: Hongwei Kang, Beijing (CN); Zixuan Zhang, Beijing (CN)

(21) Appl. No.: 19/307,984

(22) Filed: Aug. 22, 2025

(30) Foreign Application Priority Data
Aug. 22, 2024 (WO) PCT/CN2024/114066

(51) Int. Cl. G06Q 30/0251; G06F 16/9535; G06Q 30/0601

(52) U.S. Cl. CPC G06Q 30/0256; G06F 16/9535; G06Q 30/0269; G06Q 30/06311

(57) ABSTRACT

According to embodiments of the disclosure, a method, apparatus, device, medium, and program product for content searching are provided. The method includes: obtaining a set of search queries associated with a target object; extracting a set of tags for the target object from the set of search queries, each of the set of tags indicating a keyword related to the target object in a corresponding search query; and determining, from recommended content items associated with the target object, one or more recommended content items matching one or more tags of the set of tags, to be provided to a target user group.

### CROSS-REFERENCE

This application claims priority to PCT Patent Application No. PCT/CN2024/114066, filed on Aug. 22, 2024 and entitled ‘METHOD, APPARATUS, DEVICE, MEDIUM AND PROGRAM PRODUCT FOR CONTENT SEARCHING’, which is incorporated herein by reference in its entirety.

### FIELD

Example embodiments of the present disclosure generally relate to the field of computer technology and in particular, to a method, apparatus, device, computer-readable storage medium, and computer program product for content searching.

### BACKGROUND

The Internet provides access to a wide variety of resources. For example, various applications, commodities, audio/video content, etc., may be accessed through the Internet. In addition, content delivery and service promotion through the Internet has become a new form of information propagation and is widely applied. The advertisement system supports presenting recommended content items or services to the user in different advertisement presenting opportunities, enabling the user to browse and obtain corresponding services as needed, and the like. How to provide the user with higher-quality recommended content items that better meets expectations has been a key focus of ongoing research in recommendation scenario.

### SUMMARY

In a first aspect of the present disclosure, a method for content searching is provided. The method includes: obtaining a set of search queries associated with a target object; extracting a set of tags for the target object from the set of search queries, each of the set of tags indicating a keyword related to the target object in a corresponding search query; and determining, from recommended content items associated with the target object, one or more recommended content items matching one or more tags of the set of tags, to be provided to a target user group.

In a second aspect of the present disclosure, an apparatus for content searching is provided. The apparatus includes: a query obtaining module configured to obtain a set of search queries associated with a target object; a tag extracting module configured to extract a set of tags for the target object from the set of search queries, each of the set of tags indicating a keyword related to the target object in a corresponding search query; and a content determining module configured to determine, from recommended content items associated with the target object, one or more recommended content items matching one or more tags of the set of tags, to be provided to a target user group.

In a third aspect of the present disclosure, an electronic device is provided. The device includes: at least one processing unit; and at least one memory coupled to the at least one processing unit and storing instructions executable by the at least one processing unit. The instructions, when performed by the at least one processing unit, cause the device to perform the method of the first aspect.

In a fourth aspect of the present disclosure, a computer-readable storage medium is provided. The medium stores a computer program thereon which, when performed by a processor, performs the method of the first aspect.

In a fifth aspect of the present disclosure, a computer program product is provided. The computer program product is tangibly stored in a computer storage medium and includes computer executable instructions which, when performed by a device, cause the device to perform the method of the first aspect.

It should be understood that the content described in this section is not intended to limit key or important features of embodiments of the present disclosure, nor is it intended to limit the scope of the present disclosure. Other features of the present disclosure will become easily comprehensible through the following description.

### BRIEF DESCRIPTION OF DRAWINGS

In conjunction with the accompanying drawings and with reference to the following detailed description, the above and other features, advantages, and aspects of various embodiments of the present disclosure will become more apparent. In the figures, the same or similar reference numbers refer to the same or similar elements, wherein:

FIG. 1 shows a schematic diagram of an example environment in which embodiments of the present disclosure may be implemented;

FIG. 2 shows a flowchart of a process for content searching according to some embodiments of the present disclosure;

FIG. 3 shows a schematic diagram of an example for content searching according to some embodiments of the present disclosure;

FIG. 4 shows a block diagram of an apparatus for content searching according to some embodiments of the present disclosure; and

FIG. 5 shows a block diagram of an electronic device in which one or more embodiments of the present disclosure may be implemented.

### DETAILED DESCRIPTION

The embodiments of the present disclosure will be described in more detail below with reference to the accompanying drawings. Although certain embodiments of the present disclosure are shown in the drawings, it would be appreciated that the present disclosure may be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term ‘including’ and similar terms would be appreciated as open-ended inclusion, that is, ‘including but not limited to’. The term ‘based on’ would be appreciated as ‘at least partially based on’. The term ‘one embodiment’ or ‘the embodiment’ would be appreciated as ‘at least one embodiment’. The term ‘some embodiments’ would be appreciated as ‘at least some embodiments’. Other explicit and implicit definitions may also be included below.

It would be appreciated that the data involved in this technical solution (including but not limited to the data itself, data acquisition or use) shall comply with the requirements of corresponding laws, regulations and relevant provisions.

It would be understood that, before using the technical solutions disclosed in the embodiments of the present disclosure, the types, the usage scope, the usage scenario, etc., of personal information, involved in the present disclosure should be notified to the user in a suitable manner according to the relevant laws and regulations, and the authorization of the user should be obtained.

For example, in response to an active request being received from a user, a prompt message is sent to the user to explicitly prompt the user that the operation requested by the user would need acquisition and use of personal information of the user. As such, according to prompt information, users may choose whether to provide personal information to the software or hardware, such as an electronic device, application, server or storage medium, that performs the operations of the technical solution of the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose ‘agree’ or ‘disagree’ to provide the personal information to the electronic device.

It would be appreciated that the above process of notification and acquisition of user authorization is only an example and do not limit the implementations of the present disclosure. Other methods that meet relevant laws and regulations may also be applied to the implementations of the present disclosure.

As used in this specification, the term ‘model’ may learn a correlation between respective inputs and outputs from training data, so that a corresponding output may be generated for a given input after training is completed. The generation of the model may be based on machine learning techniques. Deep learning is a machine learning algorithm that processes inputs and provides corresponding outputs by using multiple layers of processing units. A neural networks model is an example of a deep learning-based model. As used in this specification, ‘model’ may also be referred to as ‘machine learning model’, ‘learning model’, ‘machine learning network’, or ‘learning network’, and these terms are used interchangeably herein.

A ‘neural network’ is a deep learning-based machine learning network. The neural network is capable of processing inputs and providing corresponding outputs, which typically includes an input layer, output layer and one or more hidden layers between the input layer and the output layer. The neural networks used in deep learning applications typically include many hidden layers, thereby increasing the depth of the network. Respective layers of the neural network are connected sequentially thereby the output of the previous layer is provided as the input to the next layer, where the input layer receives the input of the neural network while the output of the output layer serves as the final output of the neural network. Each layer of the neural network includes one or more nodes (also referred to processing nodes or neurons), and each node processing the input from the previous layer.

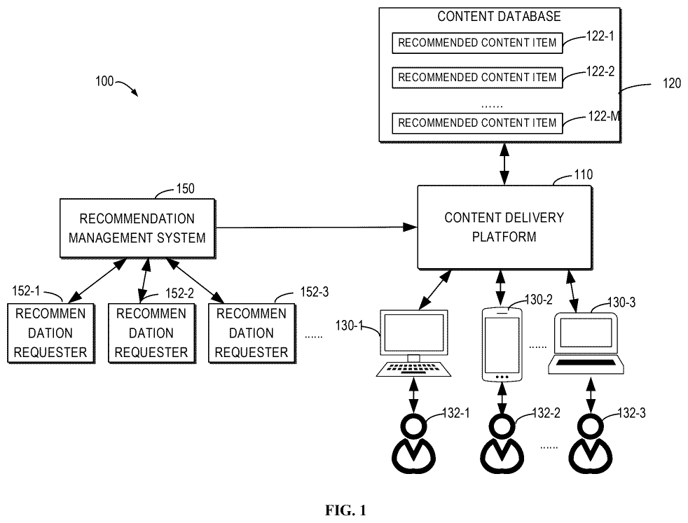

FIG. 1 shows a schematic diagram of an example environment 100 in which embodiments of the present disclosure may be implemented. One or more content providers may use a recommendation management system 150 to manage contents to be on a content delivery platform 110. One or more client devices 130-1, 130-2, 130-3, etc. (collectively or individually referred to as a client device 130 for ease of discussion) are associated with the content delivery platform 110 and may access various content provided on the content delivery platform 110, e.g., based on corresponding users 132-1, 132-2, 132-3, etc. (collectively or individually as user 132 for ease of discussion). As an example, the content delivery platform 110 may be an application, website, web page, and a further accessible platform. The client device 130 may be installed with an application for accessing the content delivery platform 110 or may access the content delivery platform 110 in a suitable manner.

The content delivery platform 110 may be configured to deliver one or more particular recommended content items (e.g., provided or presented at the client device 130) related to the one or more objects to the user group based on respective policies. The recommended content item to be delivered may include, for example, one or more recommended content items 122-1, 122-2, . . . , 122-M (collectively or individually referred to as recommended content item 122 for case of discussion, and the recommended content items may be simply referred to as recommended content).

Examples of recommendable objects may include, but are not limited to: applications, entity commodities/services, virtual commodities/services, digital content/entity content, and the like. Herein, ‘recommended content item’ refers to content associated with a recommended object, which may be presented to a corresponding user group to achieve a recommendation purpose to the corresponding object. Recommended content item is sometimes also referred to as a material content related to an object, examples of which may include advertisements including videos, images, text-image combination works, plain text content, and the like. Recommended content item may include a content uploaded by a recommendation requester and from a data source specified by the recommendation requester, or may be user generated content (UGC) (it should be noted that the use of the user-generated content is authorized by the user), and so on.

Herein, a user group may include one or more user members, such as user 132. A user member may be any potential consumer of a service, such as a user, group, organization, entity, etc.

In some embodiments, the content delivery platform 110 may distribute the corresponding recommended content items 122 to the user 130 based on requests from respective recommendation requester 152-1, 152-2, 152-3, etc. (collectively or individually referred to as ‘recommendation requester’ 152). In the scenario of advertisement delivery, a service provider is sometimes also referred to as an advertiser.

In some embodiments, the service provider may also provide cost expenditure to the content delivery platform 110 based on the presentation of the recommended content item and subsequent conversions. The conversion result for the recommended content item may include viewing, clicking, downloading, paying, adding to a shopping cart, etc., for the recommended content, and the specific conversion behavior is related to the recommended object and the service provider.

In the environment 100, the client device 130 may be any type of mobile terminal, fixed terminal, or portable terminal, including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices or any combination thereof. In some embodiments, the client device 130 may also support any type of interface for a user (such as a ‘wearable’ circuit, etc.).

In the environment 100, the content delivery platform 110 and/or recommendation management system 150 may be, for example, various types of computing systems/servers capable of providing computing power, including but not limited to mainframes, edge computing nodes, computing devices in cloud environment, etc. Although shown separately, one or more of the content delivery platform 110 and/or the recommendation management system 150 may be combined.

It should be understood that the components and arrangements in the environment shown in FIG. 1 are merely examples, and the computing system suitable for implementing the example embodiments described in this disclosure may include one or more different components, other components, and/or different arrangements. The number of elements shown in FIG. 1 is also merely an example, and more or fewer number of elements may actually exist.

Traditionally, the recommended content item corresponding to an object to be recommended is searched based on the name, brand, category, etc., of the object to be recommended. This results in obtaining similar recommended content items, with less number and serious homogenization. In addition, the plurality of recommended content items are generally ordered based on the number of user interactions (e.g., likes, favorites, views, reposts, etc.) with the plurality of recommended content items. This may lead that the recommended content item with more interactions is likely to be viewed by more users, while the recommended content item with less interactions is difficult to be viewed by the user, affecting the effect of content recommendation.

According to the embodiments of the present disclosure, an improved solution for content searching is provided. According to the solution, a set of search queries associated with a target object are obtained. A set of tags are extracted for the target object from the set of search queries, and each of the set of tags indicates a keyword related to the target object in a corresponding search query. One or more recommended content items matching one or more tags of the set of tags are determined, to be provided to a target user group, from recommended content items associated with the target object.

Therefore, a tag for recalling the recommended content items may be determined based on a set of search queries associated with the target object, improving the quality and diversity of the recalled recommended content items, and contributing to improve the quality of the content search and the quality of the content recommendation.

Some example embodiments of the present disclosure will be described below with reference to the accompanying drawings.

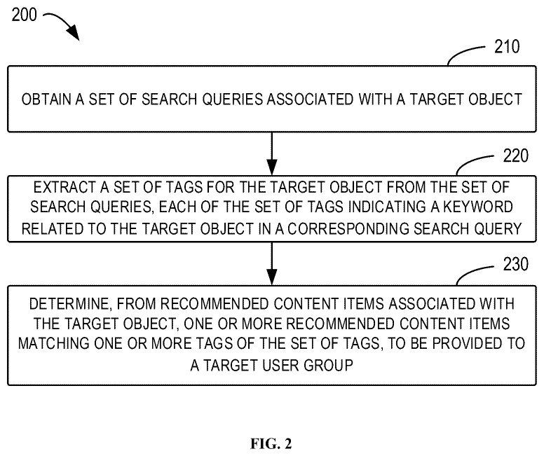

FIG. 2 shows a flowchart of a process 200 for content searching according to some embodiments of the present disclosure. For case of discussion, description will be provided in conjunction with FIG. 1. The process 200 may be implemented at the content delivery platform 110. It should be understood that embodiments of the present disclosure may also be implemented in any suitable device or system.

At block 210, the content delivery platform 110 obtains a set of search queries associated with a target object. The target object, that is, the object to be recommended, may be any suitable object, examples of which may include an application, entity commodity/service, virtual commodity/service, digital content/entity content, and the like.

The content delivery platform 110 may, for example, obtain a set of search queries from at least one search engine. The search engine may correspond to a search function in any suitable application or website.

In some embodiments, the content delivery platform 110 may obtain a seed word corresponding to the target object and determine a search query associated with the target object from the search queries using the seed word. The seed word of the target object may accurately define or describe the target object, which may include, for example, a name, brand, type, attribute (for example, a function, tag, and the like) of the target object, and the like. The seed word of the target object may be predefined by a user (for example, a backend staff member, a promoter, etc.), or may be automatically determined by the content delivery platform 110. The number of seed words may be one or more. For example, if the target object is commodity A of brand A with a name of XX and a function of YY, the seed words of the target object may include, for example, ‘brand A,’ ‘commodity A,’ ‘XX,’ ‘YY,’ and the like.

The search query obtained from the at least one search engine may be a historical search query issued by the user in a search engine over a period of time in the past. The historical search query may be obtained in real time or in advance. This is not limited in the present disclosure. The content delivery platform 110 may further obtain, based on a seed word corresponding to the target object, a set of search queries matching the seed word from historical search queries.

The matched search queries may include at least a seed word, or a further word related to or similar to the seed word. It may be understood that the seed word may include at least one seed word, and each of the set of search queries may include one or more seed words of the at least one seed word. Taking the example of seed words including word A and word B, the set of search queries may include, for example, a search query including only word A (e.g., ‘function of word A,’ ‘word A may . . . ’, ‘word A is . . . ’, etc.), a search query including only word B (e.g., ‘word B may . . . ’, ‘word B is . . . ’, etc.), and a search query including both word A and word B (e.g., ‘word A, word B may . . . ’, etc.).

Alternatively, or in addition, in some embodiments, the content delivery platform 110 may further obtain, based on a seed word corresponding to the target object directly, a set of historical search queries matching the seed word from at least one search engine, and determine the set of historical search queries as a set of search queries associated with the target object.

In some embodiments, if the target user group is a user group to be recommended, in addition to the seed word of the target object, the content delivery platform 110 may further determine a set of search queries based on a target geographical region where the target user is located, target time (for example, a festival or special date), target user type and the like. For example, the historical search query as well as the region information and the timestamp corresponding to each historical search query may be obtained first, then a set of search queries matching the seed word, the target geographic region, and the target time may be obtained from the historical search query.

Since the search query is initiated by the user when he/she wants to search for a query, the features and characteristics that the user is concerned about for the target object may be accurately reflected. Therefore, the object tag extracted from the historical search query may help retrieve the recommended content item that matches the demand of the user better during the object recommendation process.

At block 220, the content delivery platform 110 extracts a set of tags for the target object from the set of search queries, each of the set of tags indicating a keyword related to the target object in a corresponding search query.

In some embodiments, the content delivery platform 110 may directly extract a set of tags for the target object from a set of search queries. Alternatively or in addition, in some embodiments, to improve the quality of the extracted tags, the content delivery platform 110 may also perform a preprocessing operation on a set of search queries and extract a set of tags for the target object from the preprocessed set of search queries. The preprocessing operation may at least include, for example, at least one of: a data cleaning operation, or a data merging operation. The data cleaning operation may include performing error correction, incompleteness, deduplication, unifying format, marking exceptions, and the like on a set of search queries. Performing a data cleaning operation on a set of search queries may improve the accuracy, completeness, consistency, and validity of a set of search queries. The data merging operation may include integrating at least one search query of the set of search queries to obtain a completer and more comprehensive search query. Thus, an incorrect or non-standard search query in a set of search queries may be removed via the preprocessing operation, and the tag may be determined via the preprocessed set of search queries. Data preprocessing helps to improve the quality of subsequently determined tags. A further data preprocessing operation may be performed based on actual needs.

The content delivery platform 110 may extract a set of tags from a set of search queries in any suitable manner, and the present disclosure does not limit specific extraction manner. As an example, the content delivery platform 110 may cluster a set of search queries to obtain a set of clusters. The content delivery platform 110 may cluster a set of search queries using any suitable clustering algorithm. The applicable clustering algorithms include but not limited to, K-means clustering algorithms, Gaussian Mixture Model (GMM) clustering algorithms, density-based spatial clustering of applications with noise (DBSCAN) clustering algorithms, hierarchical clustering algorithms, etc. Each cluster includes at least one search query of the set of search queries. For each cluster, the at least one search query included in the cluster may be a search query of the same type. For example, at least one search query in cluster A may respectively be a search query associated with the appearance of the target object.

For each cluster in the set of clusters, the content delivery platform 110 may determine description information for the cluster from at least one search query included in the cluster. The content delivery platform 110 may determine the description information for the cluster in any suitable manner. For example, the content delivery platform 110 may determine the description information for the cluster based on a predetermined rule or algorithm. For a further example, the content delivery platform 110 may further determine description information for the cluster from at least one search query included in the cluster with a machine learning model.

For example, the content delivery platform 110 may provide a cluster and a prompt that indicate the machine learning model to determine the description information for the cluster, to the machine learning model. The machine learning model may be based on any suitable model structure, including but not limited to any suitable model such as a Transformer model, convolutional neural network (CNN), recurrent neural network (RNN), deep neural network (DNN), etc. In some embodiments, the machine learning model may be a language model (LM).

Such a machine learning model may perform content generation by guidance of the prompt to handle different types of tasks. The prompt may be, for example, ‘Please determine description information for the cluster based on at least one search query included in the following cluster’. It may be understood that the prompt may be any suitable prompt, which is not limited in the present disclosure. The machine learning model may further generate description information for the cluster based on the received prompt. The description information for the cluster may be, for example, a description text obtained by summarizing at least one search query included in the cluster, that may describe the cluster, for example, that may be one or more sentences.

The content delivery platform 110 may determine a tag associated with the target object based on respective description information for the plurality of clusters. For example, if the at least one search query in the cluster A is a search query associated with the appearance of the target object, the tag determined based on the cluster A may indicate the appearance of the target object.

At block 230, the content delivery platform 110 determines, from recommended content items associated with the target object, one or more recommended content items matching one or more tags of the set of tags, to be provided to a target user group. The target user group, that is a user group to be received with recommended content item, includes a plurality of users. In some embodiments, the plurality of users included in the target user group may be a plurality of users with the same attribute. For example, the plurality of users included in a target user group may be users from the same geographic region, users with the same interest, and the like.

The content delivery platform 110 may obtain a recommended content item associated with the target object. The recommended content item associated with the target object may be, for example, obtained by the content delivery platform 110 from a content database, such as a content database 120.

In some embodiments, the content delivery platform 110 may determine, based on all tags of the set of tags, the recommended content items to be recommended from the recommended content items associated with the target object. In some embodiments, the content delivery platform 110 may further determine, based on only one or more tags in the set of tags, the recommended content items to be recommended from the recommended content items associated with the target object. The one or more tags herein may be, for example, determined randomly from a set of tags determined for the target object by the content delivery platform 110, or may be determined by the content delivery platform 110 based on a score corresponding to each of the set of tags. For example, the content delivery platform 110 may select one or more tags with corresponding scores exceeding a threshold from a set of tags.

The content delivery platform 110 may determine a score of each tag in any suitable manner. For example, the content delivery platform 110 may determine a score of the tag based on a weight of the tag, and the score of the tag being positively correlated to the weight of the tag. It may be understood that the score of the tag may also be associated with any other suitable factor, which is not limited in the present disclosure.

Regarding to the manner of determining the weight of the tag, in some embodiments, the content delivery platform 110 may determine a cluster corresponding to each tag. As mentioned above, the content delivery platform 110 may cluster a set of search queries to obtain a set of clusters, each cluster including at least one search query of a set of search queries, the set of tags corresponding to the set of clusters, respectively. The content delivery platform 110 may determine a weight of a tag corresponding to a respective cluster of the set of clusters based on the number of search queries included in the respective cluster, wherein a value of weight of a tag corresponding to the respective cluster is positively correlated with the number of search queries included in the respective cluster.

For example, if cluster A corresponds to tag A, cluster B corresponds to tag B, cluster A includes 200 search queries and cluster B includes 100 search queries. Since the number of search queries included in cluster A is greater than the number of search queries included in the cluster B, the weight corresponding to tag A is greater than the weight corresponding to tag B.

In some embodiments, the content delivery platform 110 may determine, from the recommended content items associated with the target object, all recommended content items matching the one or more tags as recommended content items to be recommended to the target user group. In some embodiments, the content delivery platform 110 may further determine, based on respective weights corresponding to one or more tags of the set of tags, one or more recommended content items matching the one or more tags from the recommended content items associated with the target object. The number of recommended content items matching each tag may be positively correlated with the weight corresponding to that tag.

Specifically, if the one or more tags including a first tag and a second tag, and the weight corresponding to the first tag is greater than the weight of the second tag, the content delivery platform 110 may determine, based on the first tag, a first number of recommended content items from the recommended content items associated with the target object. The content delivery platform 110 may further determine, based on the second tag, a second number of recommended content items from the recommended content items associated with the target object, wherein the second number is less than the first number.

For example, if the recommended content items associated with the target object including 200 content items matching tag A and 200 content items matching tag B, and the weight of tag A is greater than the weight of tag B, the content delivery platform 110 may determine 70 content items corresponding to tag A and 30 content items corresponding to tag B from the recommended content items associated with the target object.

In some embodiments, based on one or more tags in the set of tags directly, the content delivery platform 110 may further determine from a content database recommended content items matching the one or more tags. The content delivery platform 110 may determine an association degree between the target object and each of the recommended content items matching the one or more tags, and determine the recommended content items with association degree exceeding a predetermined threshold as the recommended content items to be recommended to the target user group.

For example, taking the target object as object A as an example, the content delivery platform 110 may determine, based on the one or more tags, recommended content item A, recommended content item B, and recommended content item C from a content database. If among the recommended content A, recommended content B, and recommended content C, the recommended content A and recommended content C are recommended content for the target object A, and the recommended content B is recommended content for the target object B, the content delivery platform 110 may determine that an association degree between the recommended content B and the target object A is low, and that an association degree between the recommended content A and the recommended content C and the target object A is high. The content delivery platform 110 may further recommend the recommended content item A and the recommended content item C to the target user group.

In a content recommendation scenario, a recommended content item itself is labelled with one or more tags, and these tags are determined for the content included in the recommended content item. For example, if the recommended content item is a test video about a certain electronic product, the tag of the recommended content item may be determined to include a name, test point (e.g., an appearance feature, waterproofness, memory capacity), tester, test environment of the electronic product, etc. If the target object to be recommended is the electronic product, then through the tag determination process described above, it can be determined for that target object that the tag that the user is more concerned about is the waterproofness of the electronic product (e.g., Product A, high waterproofness.) Then, through the tag matching, this test video can be found from the many optional recommended content items to be use in recommending to the target user group.

In some embodiments, after determining the recommended content item to be recommended to the target user group, the content delivery platform 110 may further process the recommended content item, such as by ranking and filtering, etc., and provide the processed recommended content item to the target user group. For example, the content delivery platform 110 may determine a quality score of a respective one of the one or more recommended content items matching the one or more tags based on at least one of the following: content feature information of the respective one of the one or more recommended content items matching the one or more tags, or user attribute information of the target user group.

The content feature information of the respective recommended content item may, for example, indicate a category, style, and the like of the corresponding recommended content item. The user attribute information of the target user group may, for example, indicate historical behavior data of the target user group, object attribute information that the target user group is interested in (for example, a price, type, marketing activity, and the like of the object that the target user group is interested in), and the like. The historical behavior data of the target user group may, for example, indicate whether the user performs a particular conversion behavior on the target object over a period of time (for example, clicking, adding to a shopping cart, ordering, purchasing, reposting, liking, favoriting, downloading, etc.), whether the user completely views the media content with the target object over a period of time, whether the user performs a search on the target object or the media content over a period of time, and the like.

The content delivery platform 110 may determine, in any suitable manner, a quality score of a respective one of the one or more recommended content items matching the one or more tags based on content feature information of the respective one of the one or more recommended content items matching the one or more tags and/or user attribute information of the target user group. For example, the content delivery platform 110 may determine the quality score of each recommended content item by means of a trained machine learning model (such as a ranking model).

The content delivery platform 110 may further determine, based on the quality scores of the one or more recommended content items, a collection of recommended content items with the corresponding quality scores exceeding a threshold score from the recommended content items matching the one or more tags, to be provided to the target user group. Alternatively or in addition, the content delivery platform 110 may also rank (e.g., in descending ranking) the one or more recommended content items matching the one or more tags based on the quality score of the respective recommended content item. The content delivery platform 110 may further determine, based on the ranking result, a collection of recommended content items with the corresponding ranking exceeding a threshold ranking from the recommended content matching the one or more tags, to be provided to the target user group.

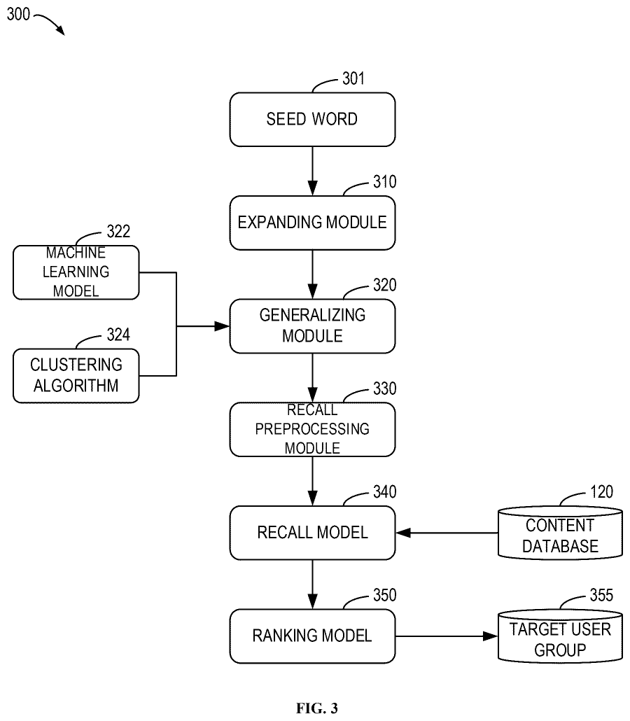

FIG. 3 shows a schematic diagram of an example architecture 300 for content searching according to some embodiments of the present disclosure. The architecture 300 may be implemented at the content delivery platform 110. As shown in FIG. 3, the architecture 300 relates to an expanding module 310, a generalizing module 320, a recall preprocessing module 330, a recall model 340, and a ranking model 350. The expanding module 310 may obtain a seed word corresponding to the target object, and obtain, based on a seed word 301 corresponding to the target object, a set of search queries matching the seed word from historical search queries. The set of search queries is also a set of search queries associated with the target object. The generalizing module 320 may extract a set of tags for the target object from the set of search queries by means of a machine learning model 322 and/or based on a clustering algorithm 324.

For example, the generalizing module 320 may obtain a set of clusters by using the clustering algorithm 324 to cluster a set of search queries, each cluster including at least one search query of the set of search queries. The generalizing module 320 may determine, for each cluster in a set of clusters, description information for the cluster from the at least one search query included in the cluster by means of the machine learning model 322, and determine a tag associated with the target object based on the description information.

The recall preprocessing module 330 may perform data cleaning operation and/or data merging operation on a set of tags to improve the quality of the set of tags. It should be noted that the recall preprocessing module 330 may be after the generalizing module 320 as shown in FIG. 3 or may be before the generalizing module 320. If the recall preprocessing module 330 is before the generalizing module 320, it may perform a data cleaning operation and/or data merging operation on a set of search queries.

The recall model 340 may determine, based on one or more tags of a set of tags, one or more recommended content items matching the one or more tags from the content database 120. In some embodiments, the recall model 340 may first determine the recommended content item associated with the target object from the content database 120, and then determine, based on the one or more tags, one or more recommended content items matching the one or more tags from the recommended content items associated with the target object, to be provided to the target user group. In some further embodiments, the recall model 340 may further determine, based on one or more tags, one or more recommended content items matching the one or more tags from the content database 120. The recall model 340 may further determine, based on a determined association degree of each recommended content item with the target object, from the recommended content items matching the one or more tags, recommended content items that are strongly associated with the target object, to be provided to a target user group 355.

The ranking model 350 may determine a quality score of a respective one of the recommended content items to be recommended to the target user group 355, and determine, based on a quality score of respective recommended content items, a collection of recommended content items with the corresponding quality scores exceeding a threshold score from the recommended content items matching the one or more tags, to be provided to the target user group 355.

In summary, tags for recalling recommended content items may be determined based on a set of search queries associated with a target object, which may improve the quality as well as the richness of the recalled recommended content items, and help to improve the quality of the content search as well as the quality of the content recommendations.

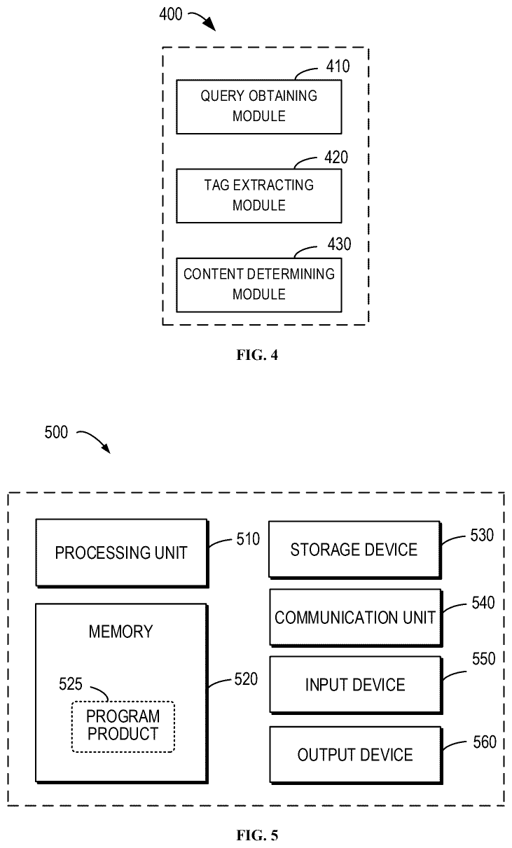

FIG. 4 shows a block diagram of an apparatus 400 for content searching according to some embodiments of the present disclosure. The apparatus 400 may be implemented or included in the content delivery platform 110. The various modules/components in the apparatus 400 may be implemented in hardware, software, firmware, or any combination thereof.

As shown, the apparatus 400 includes a query obtaining module 410 configured to obtain a set of search queries associated with a target object. The apparatus 400 further includes a tag extracting module 420 configured to extract a set of tags for the target object from the set of search queries, each of the set of tags indicating a keyword related to the target object in a corresponding search query. The apparatus 400 further includes a content determining module 430 configured to determine, from recommended content items associated with the target object, one or more recommended content items matching one or more tags of the set of tags, to be provided to a target user group.

In some embodiments, the query obtaining module 410 is further configured to: obtain, based on a seed word corresponding to the target object, a set of search queries matching the seed word from historical search queries.

In some embodiments, the historical search queries are obtained from at least one search engine.

In some embodiments, the tag extracting module 420 includes: a clustering module configured to cluster the set of search queries to obtain a set of clusters, each cluster comprising at least one search query of the set of search queries; and a tag determining module configured to, for each cluster in the set of clusters, determine description information for the cluster from the at least one search query comprised in the cluster, and determine a tag associated with the target object based on the description information.

In some embodiments, the tag determining module is further configured to: determine, using a machine learning model, description information for the cluster from at least one search query comprised in the cluster.

In some embodiments, the tag extracting module 420 includes: a preprocessing module configured to perform a preprocessing operation on a set of search queries, wherein the preprocessing operation at least includes at least one of: a data cleaning operation, or a data merging operation; and an extracting module configured to extract a set of tags associated with the target object from the preprocessed set of search queries.

In some embodiments, the content determining module 430 is further configured to determine, based on respective weights corresponding to one or more tags of the set of tags, one or more recommended content items matching the one or more tags from the recommended content items associated with the target object.

In some embodiments, a weight corresponding to each tag is determined by: clustering the set of search queries to obtain a set of clusters, each cluster including at least one search query of the set of search queries, and the set of tags corresponding to the set of clusters, respectively; and determining a weight of a tag corresponding to a respective cluster of the set of clusters based on the number of search queries included in the respective cluster, where a value of a weight of a tag corresponding to the respective cluster is positively correlated with the number of search queries included in the respective cluster.

In some embodiments, the content determining module 430 is further configured to: in response to the one or more tags including a first tag and a second tag, and a weight corresponding to the first tag being greater than a weight of the second tag, determine, based on the first tag, a first number of recommended content items from the recommended content items associated with the target object; determine, based on the second tag, a second number of recommended content items from the recommended content items associated with the target object, wherein the second number is less than the first number.

In some embodiments, the apparatus 400 further includes: a score determining module configured to determine a quality score of a respective one of the one or more recommended content items matching the one or more tags based on at least one of the following: content feature information of the respective one of the one or more recommended content items matching the one or more tags, or user attribute information of the target user group; and a collection determining module configured to determine, based on the quality score of the respective one of the one or more recommended content items, a collection of recommended content items with the corresponding quality scores exceeding a threshold score from the recommended content items matching the one or more tags, to be provided to the target user group.

The units and/or modules included in the apparatus 400 may be implemented in various manners, including software, hardware, firmware, or any combination thereof. In some embodiments, one or more units and/or modules may be implemented using software and/or firmware, such as machine executable instructions stored on a storage medium. In addition to or as an alternation to the machine executable instructions, some or all of the units and/or modules in the apparatus 400 may be implemented, at least partially, by one or more hardware logic components. By way of example but not limitation, example types of hardware logic components that may be used include field programmable gate arrays (FPGAs), application specific integrated circuits (ASICs), application specific standard products (ASSPs), systems on a chip (SOCs), complex programmable logic devices (CPLDs), etc.

It should be understood that one or more steps of the above methods may be performed by a suitable electronic device or a combination of electronic devices. FIG. 5 shows a block diagram of an electronic device 500 in which one or more embodiments of the present disclosure may be implemented. It should be understood that the electronic device 500 shown in FIG. 5 is merely an example and should not constitute any limitation on the functionality and scope of the embodiments described herein. The electronic device 500 shown in FIG. 5 may be applied to implement the feature learning and application system 110. The electronic device 500 may include or be implemented as the apparatus 400 of FIG. 4.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor capable of performing various processes according to a program stored in the memory 520. In a multiprocessor system, a plurality of processing units execute computer-executable instructions in parallel to improve the parallel processing capabilities of electronic device 500.

The electronic device 500 typically includes a variety of computer storage media. Such media may be any available media that are accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that may be used to store information and/or data and that may be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a ‘floppy disk’) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments of the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium having computer-executable instructions stored thereon is provided. The computer-executable instructions are performed by a processor to implement the method described above. According to example implementations of the present disclosure, a computer program product is further provided. The computer program product is tangibly stored on a non-transitory computer-readable medium and includes computer-executable instructions. The computer-executable instructions are performed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps may be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes may also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above. The above description is an example, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

What is claimed is:

1. A method for content searching, comprising:
obtaining a set of search queries associated with a target object;
extracting a set of tags for the target object from the set of search queries, each of the set of tags indicating a keyword related to the target object in a corresponding search query; and
determining, from recommended content items associated with the target object, one or more recommended content items matching one or more tags of the set of tags, to be provided to a target user group.

2. The method of claim 1, wherein obtaining a set of search queries associated with a target object comprises:
obtaining, based on a seed word corresponding to the target object, a set of search queries matching the seed word from historical search queries.

3. The method of claim 2, wherein the historical search queries are obtained from at least one search engine.

4. The method of claim 1, wherein extracting a set of tags for the target object from the set of search queries comprises:
clustering the set of search queries to obtain a set of clusters, each cluster comprising at least one search query of the set of search queries; and
for each cluster in the set of clusters,
determining description information for the cluster from the at least one search query comprised in the cluster, and
determining a tag associated with the target object based on the description information.

5. The method of claim 4, wherein determining the description information for the cluster comprises:
determining, using a machine learning model, description information for the cluster from at least one search query comprised in the cluster.

6. The method of claim 1, wherein extracting a set of tags for the target object from the set of search queries comprises:
performing a preprocessing operation on the set of search queries, the preprocessing operation at least comprising at least one of: a data cleaning operation, or a data merging operation; and
extracting a set of tags associated with the target object from the preprocessed set of search queries.

7. The method of claim 1, wherein determining, from recommended content items associated with the target object, one or more recommended content items matching one or more tags of the set of tags comprises:
determining, based on respective weights corresponding to one or more tags of the set of tags, one or more recommended content items matching the one or more tags from the recommended content items associated with the target object.

8. The method of claim 7, wherein a weight corresponding to a tag is determined by:
clustering the set of search queries to obtain a set of clusters, each cluster comprising at least one search query of the set of search queries, and the set of tags corresponding to the set of clusters, respectively; and
determining a weight of a tag corresponding to a respective cluster of the set of clusters based on the number of search queries comprised in the respective cluster,
wherein a value of a weight of a tag corresponding to the respective cluster is positively correlated with the number of search queries comprised in the respective cluster.

9. The method of claim 7, wherein determining, from recommended content items associated with the target object, one or more recommended content items matching one or more tags of the set of tags comprises:
in response to the one or more tags comprising a first tag and a second tag, and a weight corresponding to the first tag being greater than a weight of the second tag,
determining, based on the first tag, a first number of recommended content items from the recommended content items associated with the target object;
determine, based on the second tag, a second number of recommended content items from the recommended content items associated with the target object, wherein the second number is less than the first number.

10. The method of claim 1, further comprising:
determining a quality score of a respective one of the one or more recommended content items matching the one or more tags based on at least one of the following: content feature information of the respective one of the one or more recommended content items matching the one or more tags, or user attribute information of the target user group; and
determining, based on the quality score of the respective one of the one or more recommended content items, a collection of recommended content items with the corresponding quality scores exceeding a threshold score from the recommended content items matching the one or more tags, to be provided to the target user group.

11. An electronic device, comprising:
at least one processor; and
at least one memory coupled to the at least one processor and storing instructions executable by the at least one processor, the instructions, when performed by the at least one processor, causing the device to perform operations comprising:
obtaining a set of search queries associated with a target object;
extracting a set of tags for the target object from the set of search queries, each of the set of tags indicating a keyword related to the target object in a corresponding search query; and
determining, from recommended content items associated with the target object, one or more recommended content items matching one or more tags of the set of tags, to be provided to a target user group.

12. The electronic device of claim 11, wherein obtaining a set of search queries associated with a target object comprises:
obtaining, based on a seed word corresponding to the target object, a set of search queries matching the seed word from historical search queries.

13. The electronic device of claim 12, wherein the historical search queries are obtained from at least one search engine.

14. The electronic device of claim 11, wherein extracting a set of tags for the target object from the set of search queries comprises:
clustering the set of search queries to obtain a set of clusters, each cluster comprising at least one search query of the set of search queries; and
for each cluster in the set of clusters,
determining description information for the cluster from the at least one search query comprised in the cluster, and
determining a tag associated with the target object based on the description information.

15. The electronic device of claim 14, wherein determining the description information for the cluster comprises:
determining, using a machine learning model, description information for the cluster from at least one search query comprised in the cluster.

16. The electronic device of claim 11, wherein extracting a set of tags for the target object from the set of search queries comprises:
performing a preprocessing operation on the set of search queries, the preprocessing operation at least comprising at least one of: a data cleaning operation, or a data merging operation; and
extracting a set of tags associated with the target object from the preprocessed set of search queries.

17. The electronic device of claim 11, wherein determining, from recommended content items associated with the target object, one or more recommended content items matching one or more tags of the set of tags comprises:
determining, based on respective weights corresponding to one or more tags of the set of tags, one or more recommended content items matching the one or more tags from the recommended content items associated with the target object.

18. The electronic device of claim 17, wherein a weight corresponding to a tag is determined by:
clustering the set of search queries to obtain a set of clusters, each cluster comprising at least one search query of the set of search queries, and the set of tags corresponding to the set of clusters, respectively; and
determining a weight of a tag corresponding to a respective cluster of the set of clusters based on the number of search queries comprised in the respective cluster,
wherein a value of a weight of a tag corresponding to the respective cluster is positively correlated with the number of search queries comprised in the respective cluster.

19. The electronic device of claim 17, wherein determining, from recommended content items associated with the target object, one or more recommended content items matching one or more tags of the set of tags comprises:
in response to the one or more tags comprising a first tag and a second tag, and a weight corresponding to the first tag being greater than a weight of the second tag,
determining, based on the first tag, a first number of recommended content items from the recommended content items associated with the target object;
determine, based on the second tag, a second number of recommended content items from the recommended content items associated with the target object, wherein the second number is less than the first number.

20. A non-transitory computer readable storage medium having a computer program stored thereon, the computer program, when performed by a processor, performing operations comprising:
obtaining a set of search queries associated with a target object;
extracting a set of tags for the target object from the set of search queries, each of the set of tags indicating a keyword related to the target object in a corresponding search query; and
determining, from recommended content items associated with the target object, one or more recommended content items matching one or more tags of the set of tags, to be provided to a target user group.
